(19) United States
(12) Patent Application Publication
(10) Pub. No.: US 2006/0063482 A1
(43) Pub. Date: Mar. 23, 2006

(54) Apparatus and method for receiving a broadcasting service in a digital multimedia broadcasting system

(75) Inventors: Joon-Won Ko, Seoul (KR); Suk-Jin Jung, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/228,778

(22) Filed: Sep. 16, 2005

(30) Foreign Application Priority Data
Sep. 20, 2004 (KR) 75172-2004

(51) Int. Cl. H04H 1/00

(52) U.S. Cl. 455/3.01; 455/3.04

(57) ABSTRACT

An apparatus and method for receiving a broadcasting service in a digital multimedia broadcasting (DMB) system. In a method for changing a broadcasting service in a terminal for receiving DMB services, it is determined if a reserved decoding resource element is present while data of a first broadcasting service is decoded and output. If the reserved decoding resource element is present, it is determined if an operation for decoding a pilot channel will be stopped. If the operation for decoding the pilot channel is stopped, data of a second broadcasting service is received and decoded using the reserved decoding resource element and a decoding resource element for decoding the pilot channel. When a user makes a change to the second broadcasting service, the data of the first and second broadcasting services is simultaneously output.

### PRIORITY

This application claims priority under 35 U.S.C. § 119 to an application entitled “Apparatus and Method for Receiving a Broadcasting Service in a Digital Multimedia Broadcasting System” filed in the Korean Intellectual Property Office on Sep. 20, 2004 and assigned Serial No. 2004-75172, the contents of which are incorporated herein by reference.

### BACKGROUND OF THE INVENTION

1. Field of the Invention

The present invention relates generally to an apparatus and method for receiving a broadcasting service in a broadcasting system, and more particularly to an apparatus and method for receiving digital multimedia broadcasting (DMB).

2. Description of the Related Art

Generally, digital broadcasting provides users with high-quality images, compact disk (CD)-quality sounds, and high-level services that can replace the conventional analog broadcasting. A digital broadcasting system is commonly divided into a terrestrial broadcasting system and a satellite broadcasting system. The terrestrial broadcasting system provides a broadcasting service through a repeater on the ground. The satellite broadcasting system provides a broadcasting service through a satellite. Accordingly, a user terminal receiving terrestrial broadcasting receives a broadcasting service through the repeater, and a user terminal receiving satellite broadcasting receives a broadcasting service through the satellite.

Digital broadcasting uses Motion Picture Experts Group-2 (MPEG-2) and MPEG-4 techniques to provide high-quality images and sounds. The two techniques compress and transmit broadcasting service traffic at a high compression rate. The data is compressed using MPEG-2 or MPEG-4 at the high compression rate to decrease the amount of broadcasting service data that must be transmitted at a high-speed transmission.

For example, one system providing a digital broadcasting service is a digital multimedia broadcasting (DMB) system. It is noted that a terminal must have a structure capable of receiving five channels for one broadcasting service to meet the standard requirements in the DMB system.

FIG. 1 illustrates a structure of channels necessary to receive one broadcasting service in a terminal of the conventional DMB system. More specifically, types and functions of the channels necessary to receive the broadcasting service in the terminal of the conventional DMB system will be described with reference to FIG. 1.

Referring to FIG. 1, the five channels necessary to receive one broadcasting service in the DMB system are different from each other. The channels are classified into Channel 0, Channel 1, Channel 2, Channel 3, and Channel 4. In FIG. 1, a channel 100, corresponding to Channel 0, transfers conditional access system (CAS) information. A channel 102, corresponding to Channel 1, transfers electronic program guide (EPG) information. A channel 104, corresponding to Channel 2, and a channel 106, corresponding to Channel 3, transfer a specific broadcast.

In FIG. 1, it is assumed that Broadcasting A is received. Broadcasting A-1 and Broadcasting A-2 are distinguished from each other in order to indicate that Broadcasting A is provided through Channel-2 104 and Channel-3 106. Channel-4 108 transfers pilot information.

As is apparent from the above description, Channel-2 104 and Channel-3 106 are the channels for actually transferring the broadcasting traffic. That is, the DMB system is designed such that broadcasting traffic for one broadcasting service can be transferred through two channels.

When a broadcasting service is provided, the DMB system must interleave broadcasting traffic in units of very large data blocks, and transfer the interleaved broadcasting traffic according to the standard requirements. That is, because an encoder of a transmitter interleaves encoded data in units consisting of very large data blocks and transfers the interleaved data, a user terminal or receiver can only decode after receiving all the interleaved data. More specifically, deinterleaving is possible only when all data interleaved in the units of large data blocks is received, and a decoding can only be performed when the deinterleaving process is completed. Accordingly, because a terminal of the DMB system can decode broadcasting service traffic after receiving data of a size necessary to perform the deinterleaving, the broadcasting service is significantly delayed.

The broadcasting service traffic received through the above-described channels is input to decoding resources after a RAKE receiver, such that the decoding resources decode the input traffic. The decoding resources include a deinterleaver for deinterleaving the received traffic and a decoder for decoding the received traffic.

A delay time required to provide a broadcasting service occurs when the terminal initiates the service, and when a user requests another broadcasting channel because traffic of each broadcasting service is provided after it is interleaved. A delay time when the broadcasting service is initially received is the same as a delay time occurring when another broadcasting service is requested while the terminal receives a broadcasting service of a specific channel.

FIG. 2 is a timing diagram illustrating a delay time when a broadcasting service is changed in the conventional DMB system. Referring to FIG. 2, the x-axis represents time, and the y-axis represents traffic for providing a broadcasting service. A state in which the terminal first receives Broadcasting-A 200 of the DMB service is illustrated in FIG. 2. When the user requests a broadcasting service change in the terminal receiving the broadcasting service, the terminal must delete data stored in a buffer (not illustrated) to provide current Broadcasting-A 200 and receive broadcasting data of a requested channel. As described above, an amount of data stored in the buffer to provide Broadcasting-A 200 is very large, and corresponds to a data size necessary to interleave the broadcasting data.

After the data stored in the buffer is deleted, a time interval for receiving Broadcasting-B 204 corresponding to the requested broadcasting service and storing broadcasting data in the buffer is smaller than a time interval between a time point T₀₀ and a time point T₀₂ of FIG. 2. When the data is stored in the buffer, the terminal can decode the data stored in the buffer using the decoding resources. It should be noted that an amount of data stored in the buffer must be at least equal to that of interleaved data such that Broadcasting-B 204 corresponding to the requested broadcasting service can be provided normally.

In FIG. 2, a time interval 202 indicating a delay time due to deinterleaving/decoding includes a time interval for storing requested broadcasting service traffic and a time interval for deinterleaving and decoding stored data. That is, data of Broadcasting-B 204 corresponding to the requested broadcasting service is continuously received during the time interval 202, but the requested broadcasting service begins to be provided after the time point T₀₂.

The delay occurs because the terminal must receive all the interleaved data to deinterleave broadcasting data when the broadcasting data is interleaved and transmitted in units of large data blocks. In this case, deinterleaving and decoding times are additionally required. Accordingly, when the terminal of the DMB system with a large interleaving size desires to change the broadcasting service, it cannot provide the broadcasting service until all the interleaved data is received.

Even though the terminal has received all the data, it does not provide broadcasting data during a time interval of the deinterleaving and decoding operations.

When Broadcasting-A 200 is changed to Broadcasting-B 204 in response to a request at the time point T₀₀, the reception of Broadcasting-A 200 is stopped, and no broadcasting is provided during the time interval 202 when data of Broadcasting-B 204 is deinterleaved. After the data of Broadcasting-B 204 is completely deinterleaved and decoded, it is output. Herein, the deinterleaving time and the decoding time are referred to as the delay time.

The DMB system interleaves broadcasting traffic in units of large data blocks such that a receiver can correct a data transmission error when a transmitter transmits data. When desiring to deinterleave and decode the data, the receiver must receive the interleaved data. However, when desiring to change the broadcasting service in the DMB system, the user is inconvenienced because no broadcasting service is provided between the time point T₀₀ and the time point T₀₂ as illustrated in FIG. 2.

### SUMMARY OF THE INVENTION

It is, therefore, an object of the present invention to provide an apparatus and method for receiving a broadcasting service that provide convenience to users in a digital multimedia broadcasting (DMB) system.

It is another object of the present invention to provide an apparatus and method for receiving a broadcasting service that minimize a delay of the broadcasting service when a broadcasting service change request is made in a digital multimedia broadcasting (DMB) system.

It is yet another object of the present invention to provide an apparatus and method for receiving a broadcasting service that provides a picture in picture (PIP) service in a digital multimedia broadcasting (DMB) system.

The above and other objects of the present invention can be achieved by proving an apparatus for receiving a broadcasting service in a terminal of a digital multimedia broadcasting (DMB) system. The DMB system receives a pilot channel, an electronic program guide (EPG) channel, a conditional access system (CAS) channel, and two broadcasting service traffic channels. The apparatus includes: a receiving unit for receiving and decoding data of a first broadcasting service and associated information from the channels, and receiving and decoding data of a second broadcasting service through a reserved decoding resource element while the first broadcasting service is provided to a user; and a controller for determining if the reserved decoding resource element for receiving the second broadcasting service is present while the first broadcasting service is received.

The above and other objects of the present invention can also be achieved by a method for receiving a broadcasting service in a digital multimedia broadcasting (DMB) system. The DMB system receives a pilot channel, an electronic program guide (EPG) channel, a conditional access system (CAS) channel, and two broadcasting service traffic channels for transferring one boradcasting service. The method includes the steps of: decoding broadcasting service traffic of a first broadcasting service and associated information received from the channels through decoding elements; providing the first broadcasting service of the decoded traffic to a user; determining if a reserved decoding resource element is present; newly receiving a second broadcasting service through an identified reserved decoding resource element while the first broadcasting service is provided to the user, and decoding traffic of the received second broadcasting service after a preset time; and simultaneously providing the first broadcasting service and the second broadcasting service of the decoded traffic to the user.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates a structure of channels necessary for receiving a broadcasting service in a terminal of a conventional digital multimedia broadcasting (DMB) system;

FIG. 2 is a timing diagram illustrating a delay time when the conventional DMB system changes the broadcasting service;

FIG. 3A is a block diagram illustrating a DMB receiver in accordance with an embodiment of the present invention;

FIG. 3B is a block diagram illustrating a channel structure of the receiver in accordance with embodiments of the present invention;

FIG. 4 is a timing diagram illustrating a process for processing data in decoding resources of FIG. 3B when a broadcasting service is changed in accordance with an embodiment of the present invention;

FIGS. 5A and 5B are flowcharts illustrating a process for changing a broadcasting service in a DMB system in accordance with an embodiment of the present invention;

FIG. 6 is a timing diagram illustrating a process for processing data in the decoding resources of FIG. 3B when a picture in picture (PIP) service is implemented in accordance with an embodiment of the present invention;

FIG. 7 is a flowchart illustrating a method for providing the PIP service in the DMB system in accordance with an embodiment of the present invention;

FIG. 8 is a block diagram illustrating a channel structure of the receiver in accordance with embodiments of the present invention;

FIG. 9 is a timing diagram illustrating a process for processing data in decoding resources of FIG. 8 when a broadcasting service is changed in accordance with an embodiment of the present invention; and

FIG. 10 is a timing diagram illustrating a process for processing data in the decoding resources of FIG. 8 when a PIP service is implemented in accordance with an embodiment of the present invention.

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for clarity and conciseness.

In the following description, a first embodiment corresponds to a state in which a service change to Broadcasting B is performed in response to a user request while the user receives Broadcasting A, and a second embodiment corresponds to a state in which a picture in picture (PIP) function is performed to receive Broadcasting B, in response to a user request, while the user receives Broadcasting A, divide the entire screen of a display unit into sub-screens, and simultaneously output data of Broadcasting A and Broadcasting B to the sub-screens.

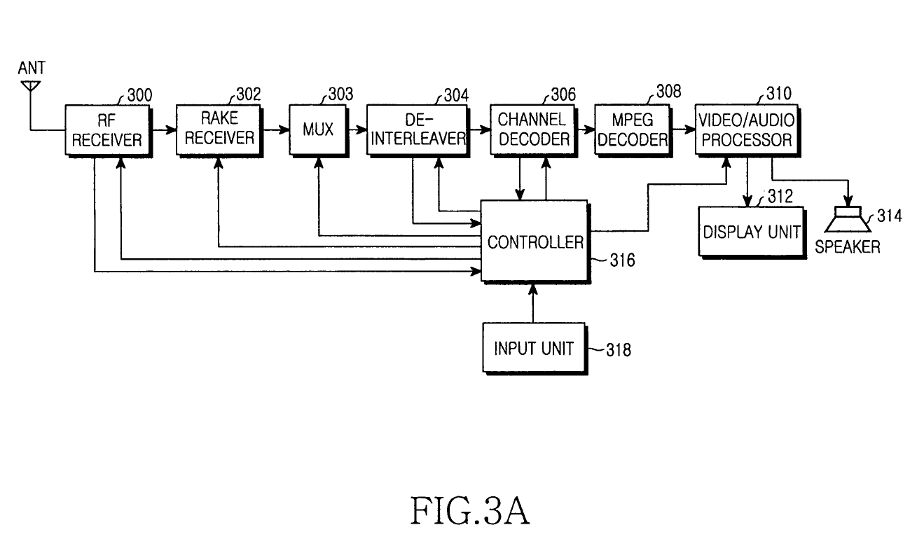

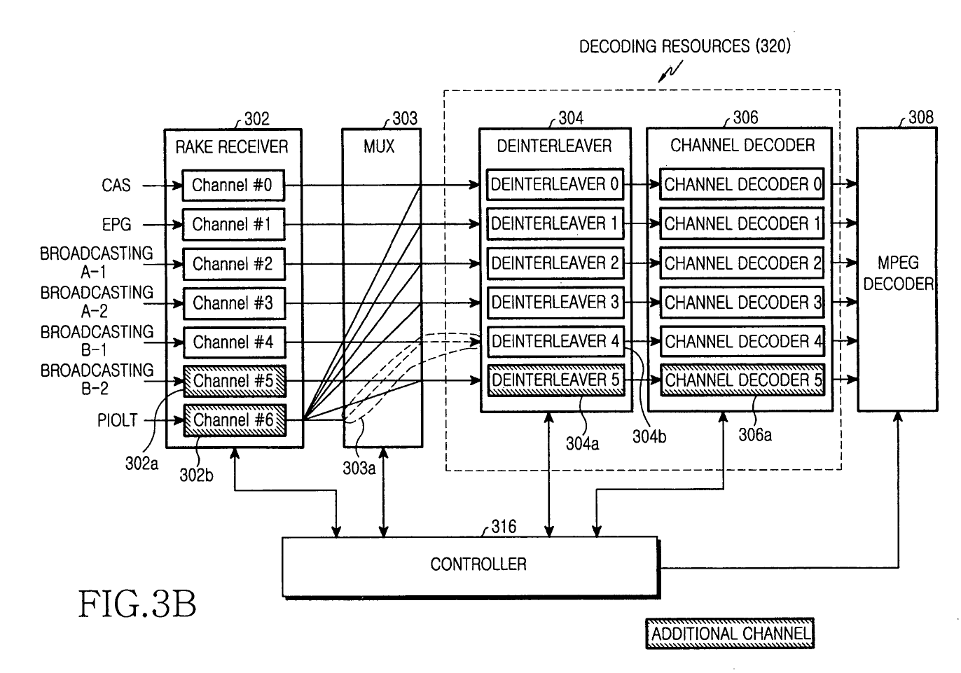

FIG. 3A is a block diagram illustrating a digital multimedia broadcasting (DMB) receiver in accordance with the present invention. Referring to FIG. 3A, the DMB receiver includes a display unit 312, a speaker 314, a controller 316, an input unit 318, and a receiving unit having an antenna (ANT), a radio frequency (RF) receiver 300, a RAKE receiver 302, a multiplexer (MUX) 303, a deinterleaver 304, a channel decoder 306, a Motion Picture Experts Group (MPEG) decoder 308, and a video/audio processor 310.

The RF receiver 300 down converts a received DMB signal frequency and then outputs the down-converted signal frequency to the RAKE receiver 302. The RAKE receiver 302 removes the effect of multipath fading and then outputs a result of the removal to the MUX 303.

Alternatively, the RAKE receiver 302 may include the MUX 303 for receiving channels of a desired broadcasting service among output signals and selecting a desired output channel. Alternatively, the MUX 303 may be configured between the RAKE receiver 302 and the deinterleaver 304.

The deinterleaver 304 receives and deinterleaves a signal output from the MUX 303. Moreover, the deinterleaver 304 has an internal buffer (not illustrated). Because no broadcasting service is provided before the internal buffer is full with desired broadcasting service traffic, the delay occurs.

The channel decoder 306 receives the deinterleaved signal from the deinterleaver 304 and decodes the received signal for error recovery. When broadcasting service traffic is included in decoded channels, the channel decoder 306 outputs the broadcasting service traffic to the MPEG decoder 308. Decoded signals are output to the display unit 312 and the speaker 314 through the video/audio processor 310, such that video and audio signals of the broadcasting service are provided to the user.

The controller 316 controls the overall operation of the DMB receiver. More specifically, when determining that reserved decoding resources of the deinterleaver 304 and the channel decoder 306 are available, the controller 316 controls new broadcasting service traffic to be decoded. Moreover, the controller 316 controls outputs of the video/audio processor 310 to be input to the display unit 312 and the speaker 314 in order to provide a PIP service. Further, the controller 316 controls the operation of the MUX 303 and changes decoding resource elements for broadcasting service traffic to be input to the deinterleaver 304. For example, a Channel-6 output of the RAKE receiver 302 is input to Interleaver-4 304b or an arbitrary deinterleaver corresponding to another decoding resource element.

The input unit 318 is an interface for receiving an operation control input from the user. In an embodiment of the present invention, a broadcasting service change request is input from the user.

In the present invention, the deinterleaver 304 and the channel decoder 306 are referred to as the decoding resources 320.

FIG. 3B is a block diagram illustrating a channel structure of the receiver in accordance with an embodiment of the present invention. Referring to FIG. 3B, the RAKE receiver 302 conventionally detects multipath fading only for five channels. However, the RAKE receiver 302 can detect multipath fading for seven channels and correct the detected multipath fading in the present invention. An operation for detecting and correcting fading for two added channels is used in a certain case to be described below.

In a general case, the fading only for the five channels is detected and corrected. For example, channels indicated by hatching in FIG. 3B are used to additionally detect fading in the RAKE receiver 302 in accordance with the present invention. That is, reserved channels used for an operation in accordance with the present invention are denoted by reference numerals 302a and 302b in FIG. 3B.

When two broadcasting channels must be received in accordance with the present invention, the RAKE receiver 302 processes signals received from the channels. Referring to FIG. 3B, the RAKE receiver 302 receives a conditional access system (CAS) signal of Channel 0, an electronic program guide (EPG) signal of Channel 1, Broadcasting A of Channels 2 and 3, Broadcasting B of Channel 4 and Channel-5 302a, and a pilot signal of Channel-6 302b. Signals processed by the RAKE receiver 302 are input to the MUX 303.

The MUX 303 multiplexes the input signals in response to a multiplexing control signal received from the controller 316 such that the multiplexed signals are input to decoding resource elements. The signals multiplexed by the MUX 303 are input to the decoding resource elements.

When control information of the pilot signal received by the RAKE receiver 302 is required in an embodiment of the present invention, the pilot signal is allocated to a desired decoding resource element of the decoding resource elements. That is, the pilot signal received from Channel-6 302b of the RAKE receiver 302 is output to Deinterleaver-4 304b of the decoding resource elements as indicated by a dashed line 303a.

As described above, the decoding resource elements are configured by deinterleaver elements and channel decoder elements. That is, one deinterleaver element and one channel decoder element configure one decoding resource element. Accordingly, the decoding resources 320 form a total of six decoding resource elements in accordance with an embodiment of the present invention. The decoding resource elements deinterleave and decode their own input signals and then output the deinterleaved and decoded signals.

Although, tan example in which the number of decoding resource elements is six has been described above, more than six decoding resource elements can be provided. That is, when three or more channels are simultaneously displayed using the PIP scheme, at least eight decoding resource elements must be provided. Accordingly, those skilled in the art will appreciate that the number of decoding resource elements can be easily increased on the basis of the description of the present invention.

Additionally, the channel decoder elements can be implemented with a device for individually decoding data received through each channel, respectively. The channel decoder devices can be implemented within one decoder.

The channel decoder elements configuring the decoding resource elements output, to the MPEG decoder 308, data compressed in the MPEG-2 or MPEG-4 format corresponding to video and audio of decoded signals on the basis of a video output control signal input from the controller 316. Other signals are output to the controller 316. Accordingly, when one broadcasting service is received through two channels, only decoded data of the two channels is output to the MPEG decoder 308. When two broadcasting services are received through four channels, decoded data of the four channels is output to the MPEG decoder 308. The controller 316 can receive a CAS signal, an EPG signal, and a pilot signal and can obtain information about received video data, information about a channel state, etc.

The deinterleaver 304 also includes a reserved deinterleaver element 304a as compared with the conventional deinterleaver. Moreover, the deinterleaver 304 deinterleaves broadcasting service traffic input on a channel-by-channel basis and outputs the deinterleaved traffic to an associated decoding resource element of the channel decoder 306.

The channel decoder 306 also includes a reserved decoder element 306a as compared with the conventional decoder. The decoder 306 receives deinterleaved broadcasting service traffic from the deinterleaver 304 through an associated channel decoder element and then decodes the received traffic. Data of Broadcasting Services A and B in the decoded broadcasting service traffic is output from the channel decoder 306 to the MPEG decoder 308. Thereafter, MPEG decoder 308 performs an associated decoding operation.

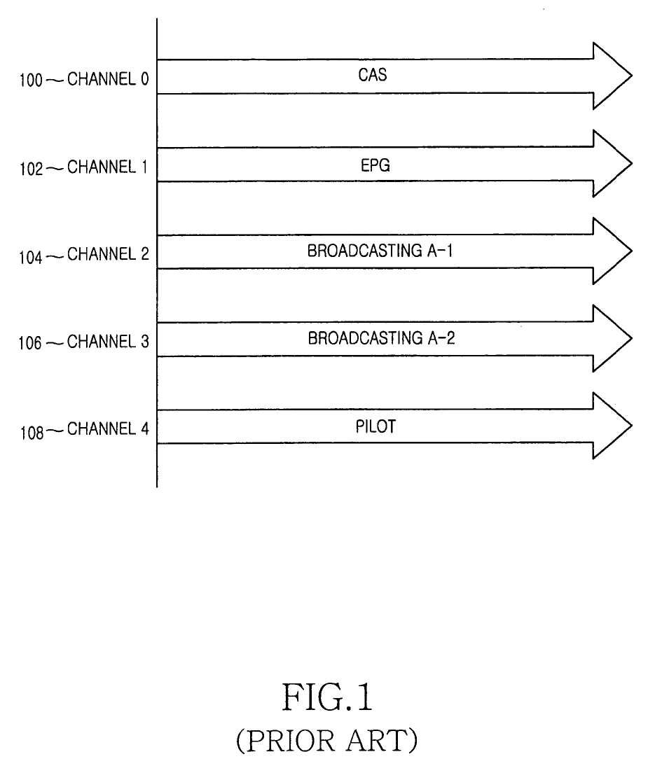

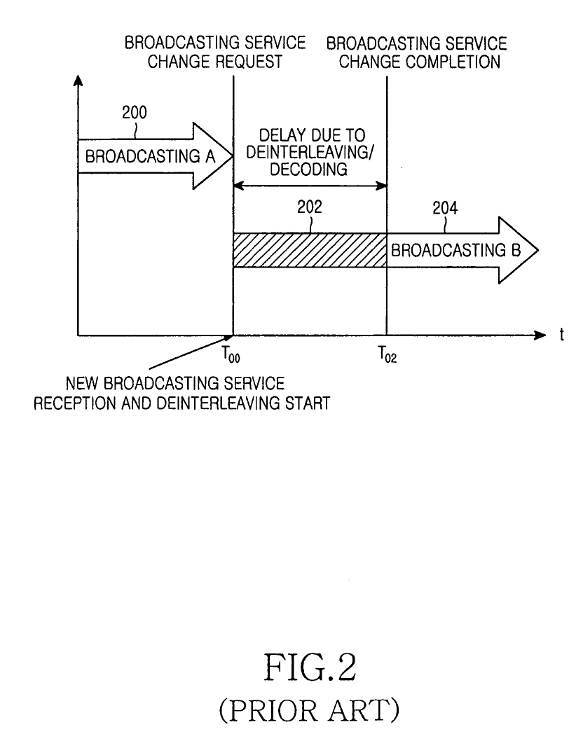

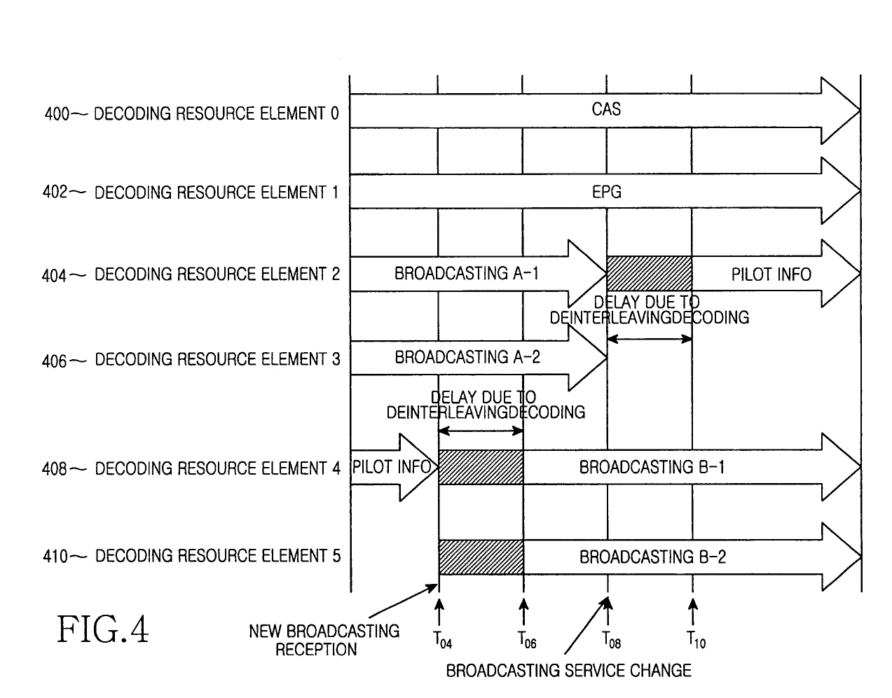

FIG. 4 is a timing diagram illustrating a process for processing data in decoding resources of FIG. 3B, after the MUX 303, when a broadcasting service is changed in accordance with the first embodiment of the present invention. Broadcasting service traffic associated with reference numerals 400 to 408 of FIG. 4 is the same as that of associated with reference numerals 100 to 108 of FIG. 1. Broadcasting service traffic is additionally decoded using one reserved decoding resource element 410, such that a broadcasting service change to be described below can be conveniently provided.

As compared with FIG. 1, Reserved Decoding Resource Element-5 410 is additionally provided in FIG. 4. Decoding Resource Element-4 408 decodes a pilot signal is set as another reserved decoding resource element for a broadcasting service change. The two reserved decoding resource elements are used as decoding resource elements for demodulation, decoding and deinterleaving when Broadcasting A associated with reference numerals 404 and 406 is changed to Broadcasting B associated with reference numerals 408 and 410.

The pilot signal received by Decoding Resource Element-4 408 contains information necessary for synchronization and control of the DMB receiver. The synchronization information contained in the pilot signal is continuously received in the RAKE receiver 302. If necessary, control information of a broadcasting signal is output to a stage after the RAKE receiver 302 and is decoded and deinterleaved. In the embodiment of the present invention, Decoding Resource Element-4 408 for decoding the pilot signal is set as a reserved decoding resource element for Broadcasting Service B along with Decoding Resource Element-5 410.

At a time point T₀₄ when control information of the pilot signal is completely received, the controller 316 controls the RAKE receiver 302 such that the pilot signal is not output to the deinterleaver 304 through the MUX 303. The RF receiver 300 and the RAKE receiver 302 output data of new Broadcasting Service B to Decoding Resource Element-4 408 for decoding the pilot signal and Reserved Decoding Resource Element-5 410 in the decoding resources 320 at the time point T₀₄.

When the data of Broadcasting Service B is input to Decoding Resource Element-4 408 and Decoding Resource Element-5 410, delay is caused by the deinterleaving and decoding.

A time point T₀₆ is a time point when the delay from the deinterleaving and decoding operations for Broadcasting Service B is ended. Two Broadcasting Services A and B can be provided to the user from the time point T₀₆. When the user requests a change to Broadcasting Service B at the time point T₀₈, the controller 316 outputs data of Broadcasting Service B associated with reference numerals 408 and 410 to the display unit 312 and the speaker 314 in real-time. If control information of the pilot signal is required during a time interval between the time point T₀₈ and a time point T₁₀, the controller 316 determines if a reserved decoding resource element is present. If a reserved decoding resource element is present, the controller 316 adjusts an output of the MUX 303 and outputs the pilot signal to the decoding resources 320.

In an embodiment of the present invention, Decoding Resource Element-2 404 for decoding Broadcasting Service A is selected as a reserved decoding resource element in the decoding resources 320. Decoding Resource Element-2 404 decodes the received pilot signal and outputs the decoded signal to the controller 316.

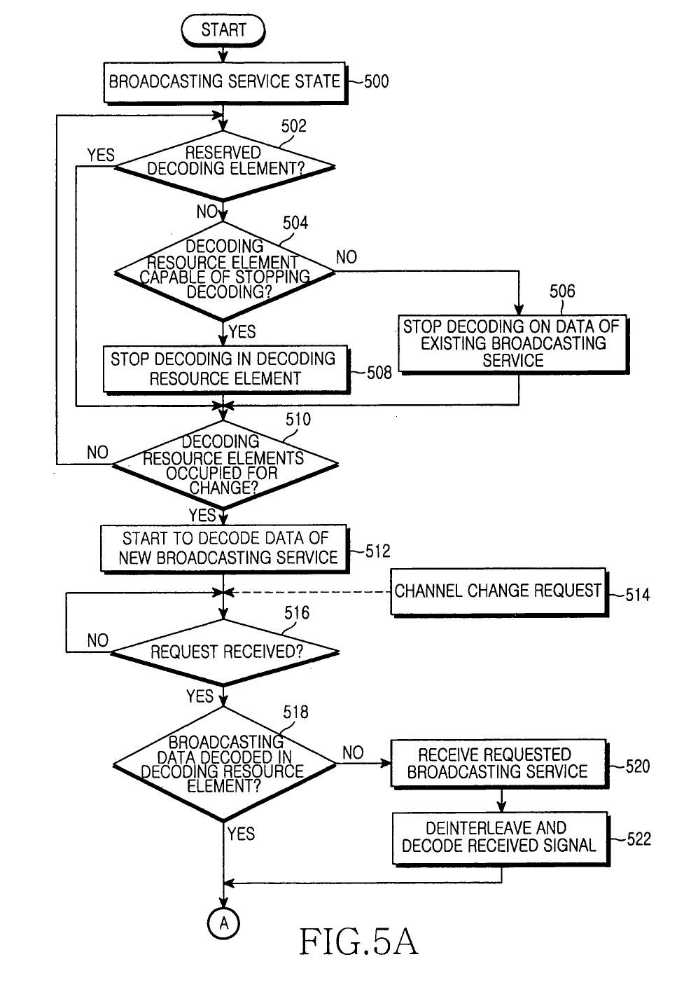

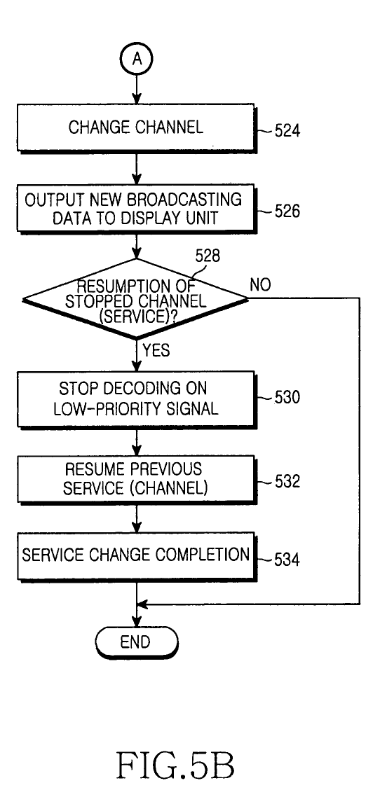

FIGS. 5A and 5B are flowcharts illustrating a process for changing a broadcasting service in a DMB system in accordance with the first embodiment of the present invention to which the receiver of FIG. 3A is applied. More specifically, the method of FIGS. 5A and 5B is performed on the basis of decoding resources with the channel structure of FIG. 4.

Referring to FIG. 5A, in a service state of Broadcasting A in step 500, the controller 316 searches for the presence of a reserved decoding resource element in the deinterleaver 304 and the channel decoder 306 in step 502 such that new Broadcasting B is received. That is, in step 502, the controller 316 determines if the reserved decoding resource element is present. If the reserved decoding resource element is not present in step 502, the controller 316 determines if a decoding resource element capable of stopping the decoding operation is present in a state in which service provision is not influenced in step 504. However, if the reserved decoding resource element is present in step 502, the operation proceeds to step 510.

If the decoding resource element capable of stopping the decoding operation is present in step 504, in step 508, the decoding operation in the decoding resource element is stopped. However, if the decoding resource element capable of stopping the decoding operation is absent, the controller 316 stops the decoding operation on data of the existing broadcasting service in step 506.

In the embodiment of the present invention, Decoding Resource Element-4 408 for receiving the control information is set as the decoding resource element capable of stopping the decoding operation in step 504.

In step 510, the controller 316 determines if a number of necessary decoding resource elements are occupied for the service change. If yes, the controller 316 starts a decoding operation for new Broadcasting Service B using the occupied decoding resources in step 512.

At this time, the DMB receiver is receiving both Broadcasting Service A and Broadcasting Service B. Broadcasting Service B may correspond to an adjacent channel of Broadcasting Service A currently being received or may be a broadcasting service predicted by the controller 316.

When a broadcasting service change request of the user is applied to the controller 316 through the input unit 318 in step 514, the controller 316 receives and detects the request for a change to a desired service, i.e., the request for a change to a desired channel, in step 516. In step 518, the controller 316 determines if Broadcasting Service B of data, currently being decoded by the reserved decoding resource elements 408 and 410, is a broadcasting service requested by the user on the basis the service change request.

If Broadcasting Service B of data currently being decoded in the reserved decoding resource elements 408 and 410 is a broadcasting service requested by the user in step 518, the controller 316 changes an output channel from Broadcasting Service A to Broadcasting Service B and input the changed output channel to the MPEG decoder 308 in step 524. However, if Broadcasting Service B of data currently being decoded is not a broadcasting service requested by the user in step 518, the controller 316 newly receives the requested broadcasting service in step 520, and the received signal is deinterleaved and decoded in step 522.

Because existing Broadcasting Service A is continuously maintained while the delay occurs due to the deinterleaving/decoding operation for the new broadcasting service, the broadcasting service is not stopped.

When the change to Broadcasting Service B is made in step 524, the controller 316 outputs the data of Broadcasting Service B newly decoded in the channel decoder 306 to the display unit 312 and the speaker 314 in step 526.

After the data of Broadcasting Service B is output, the controller 316 proceeds determine whether to resume a channel (service) in which the decoding operation is stopped due to the broadcasting service change in step 528. If the stopped channel must be resumed, the controller 316 stops a decoding operation on a low-priority signal among signals being decoded in the decoding resources in step 530.

In the first embodiment of the present invention, the resumed channel is the pilot channel, and the low-priority signal is Broadcasting Service A-1 associated with reference numeral 404.

After the decoding operation on the low-priority signal is stopped in step 530, the controller 316 resumes a previously stopped service in step 532 and completes a service change in step 534.

As described above, when control information of the pilot signal is required while the user receives Broadcasting Service B in the above-described first embodiment, one of the reserved decoding resource elements is selected to decode the control information of the pilot signal. However, if a reserved decoding resource element is present when a request for resuming a stopped channel such as the pilot signal containing the control information is absent, two Broadcasting Services A and B are simultaneously provided to the user in the second embodiment of the present invention.

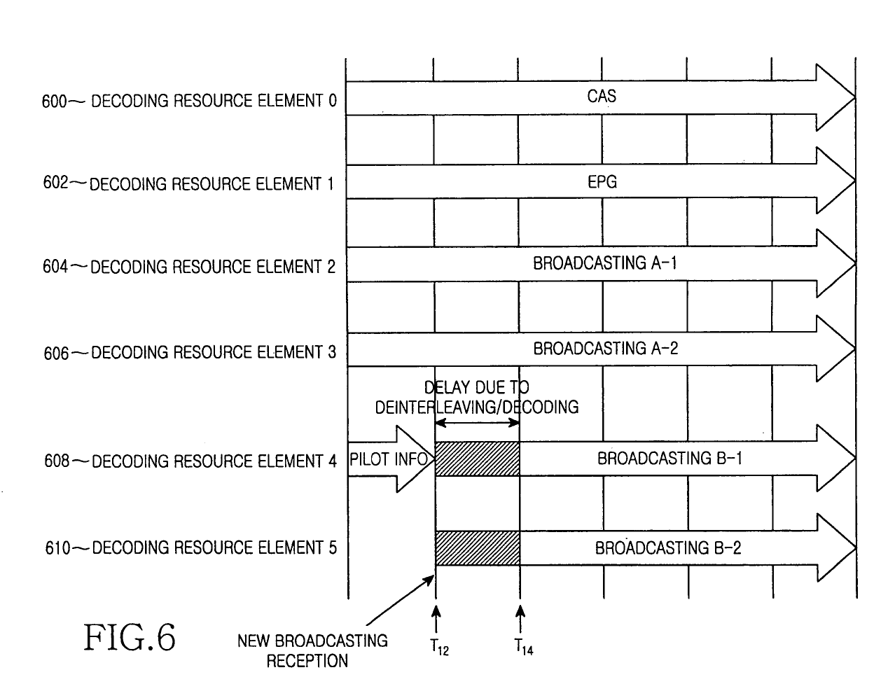

FIG. 6 is a timing diagram illustrating a process for processing data in the decoding resources of FIG. 3B when a picture in picture (PIP) service is implemented in accordance with a second embodiment of the present invention. However, because decoding resource elements denoted by reference numerals 600 to 610 of FIG. 6 are the same as those denoted by reference numerals 400 to 410 of FIG. 4, their description is omitted below.

Referring to FIG. 6, after Decoding Resource Element-4 608 completely receives control information of the pilot channel, the controller 316 stops deinterleaving and decoding operations on the pilot channel at a time point T₁₂. Decoding Resource Element-S 610 and Decoding Resource Element-4 608 decode data of new Broadcasting Service B. Accordingly, when Broadcasting Service B is provided to the user, the delay due to the decoding and deinterleaving operations occurs between the time point T₁₂ and a time point T₁₄. The time point T₁₄ is a time point when the delay due to the deinterleaving and decoding operations on data of Broadcasting Service B is ended. Because the deinterleaving and decoding operations are performed on the data of Broadcasting Service A and Broadcasting Service B in real-time at the time point T₁₄, the controller 316 can control the video/audio processor 310 to provide the PIP service.

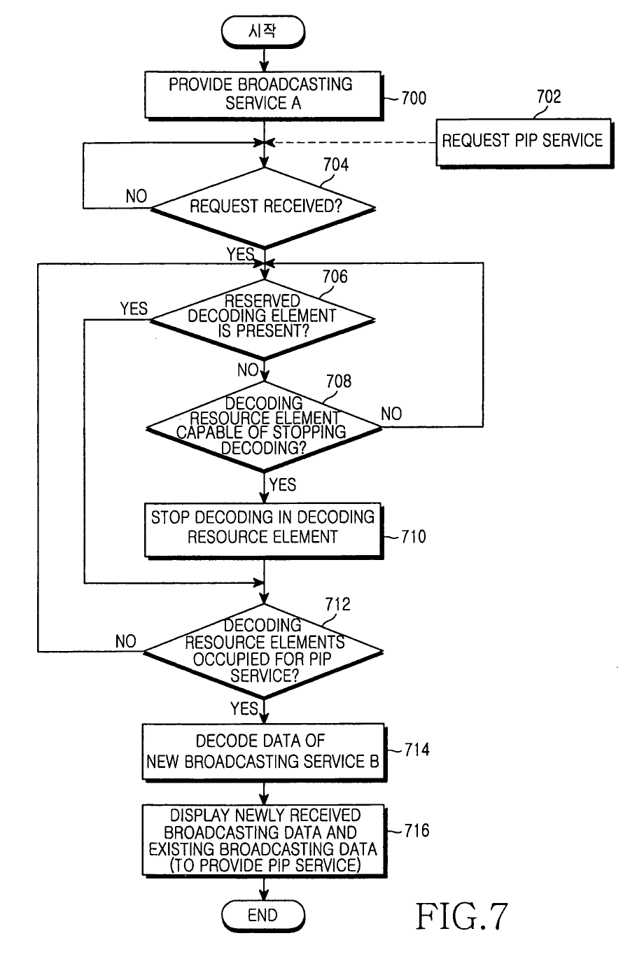

A method for providing the PIP service in the DMB system in accordance with the second embodiment of the present invention to which the receiver of FIG. 3A is applied will be described with reference to the flowchart of FIG. 7.

Referring to FIG. 7, in a state in which the service of Broadcasting A is provided in step 700, when a PIP service request of the user is applied to the controller 316 through the input unit 318 in step 702, the controller 316 receives and detects the request for a PIP service desired by the user in step 704.

To provide new Broadcasting Service B to the user on the basis of the PIP service request, the controller 316 searches for the presence of a reserved decoding resource element in step 706. That is, the controller 316 searches the deinterleaver 304 and the channel decoder 306 and determines if a reserved decoding resource element is present in step 706.

If a reserved decoding resource element is absent in step 706, the controller 316 determines if a decoding resource element capable of stopping the decoding operation is present in a state in which the service provision is not influenced in step 708. However, if a reserved decoding resource element is present in step 706, the operation proceeds to step 712.

If a decoding resource element capable of stopping the decoding operation is present in step 708, the controller 316 stops the decoding operation in the decoding resource element in step 710. However, if a decoding resource element capable of stopping the decoding operation is absent in step 708, the controller 316 repeats the process for searching for the presence of a reserved decoding resource element in step 706.

In the embodiment of the present invention, Decoding Resource Element-4 608 for decoding the pilot signal is set as a decoding resource element capable of stopping the decoding operation.

In step 710, the controller 316 stops the decoding operation in the decoding resource element capable of stopping the decoding operation. In step 712, the controller 316 determines if a number of decoding resource elements necessary to provide the PIP service have been occupied.

If the decoding resource elements have been occupied in step 712, the controller 316 decodes data of new Broadcasting Service B received in the RAKE receiver 302 using the occupied decoding resource elements in step 714. However, if the decoding resource elements have not been occupied, the controller 316 checks for the presence of a reserved decoding resource element in step 706.

The controller 316 decodes data of new Broadcasting Service B in step 714 and simultaneously outputs data of existing Broadcasting Service A and new Broadcasting Service B and provide the PIP service in step 716.

A decoding resource element for decoding a low-priority pilot channel has been set as a reserved decoding resource element in the embodiment of the present invention as described above. However, decoding resources for decoding another channel rather than the pilot channel can be set as a reserved decoding resource element.

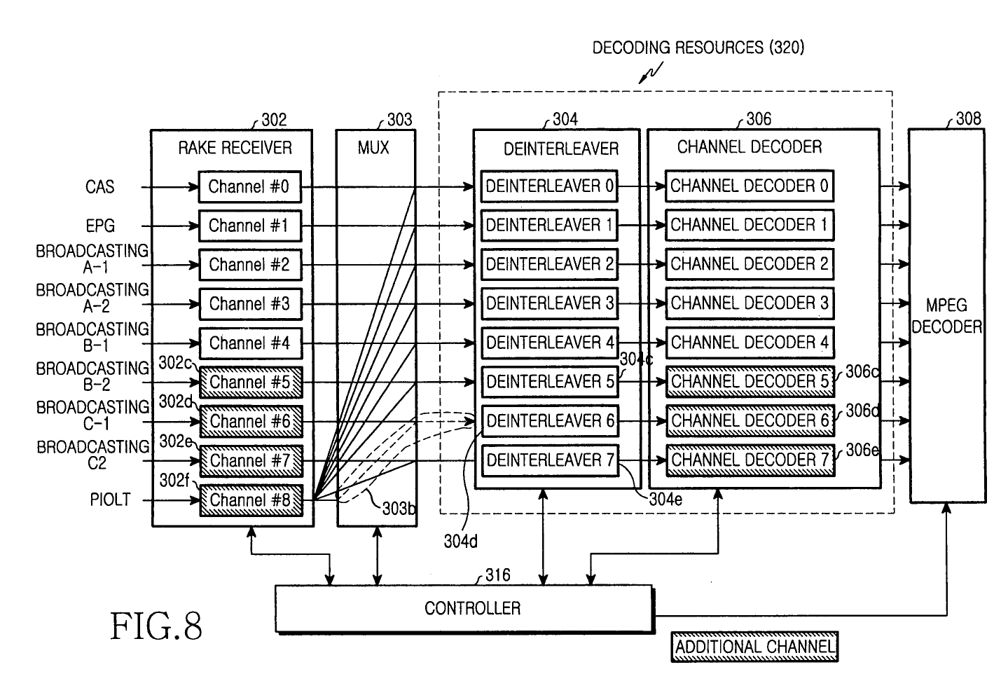

FIG. 8 is a block diagram illustrating a channel structure of the receiver in accordance with the third and fourth embodiments of the present invention. Referring to FIG. 8, the RAKE receiver 302 conventionally detects multipath fading only for five channels. However, the RAKE receiver 302 can detect multipath fading for nine channels and correct the detected multipath fading in the present invention. An operation for detecting and correcting fading for four added channels is used in a certain case to be described below. In a general case, the fading only for the five channels is detected and corrected. For example, channels indicated by hatching in FIG. 8 are used to additionally detect fading in the RAKE receiver 302 in accordance with the present invention. Reference numerals 302c, 302d, 302e, and 302f of FIG. 8 denote reserved channels used for an operation in accordance with the present invention.

When three broadcasting channels (corresponding to Broadcasting Services A, B, and C) must be received in accordance with the present invention, the RAKE receiver 302 processes signals received from the channels. Referring to FIG. 8, the RAKE receiver 302 receives a CAS signal of Channel 0, an EPG signal of Channel 1, Broadcasting Service A of Channels 2 and 3, Broadcasting Service B of Channel 4 and Channel-5 302c, Broadcasting Service C of Channel-6 302d and Channel-7 302e, and a pilot signal of Channel-8 302f. Signals processed by the RAKE receiver 302 are input to the MUX 303.

The MUX 303 multiplexes the input signals on the basis of a multiplexing control signal received from the controller 316 such that the multiplexed signals are inputs to decoding resource elements. The signals multiplexed by the MUX 303 are input to the decoding resource elements.

When control information of the pilot signal received by the RAKE receiver 302 is required in an embodiment of the present invention, the pilot signal is allocated to a desired decoding resource element of the decoding resource elements. That is, the pilot signal received from Channel-8 302f of the RAKE receiver 302 is output to Deinterleaver-6 304d of the decoding resource elements as indicated by a dashed line 303b.

As described above, the decoding resource elements are configured by deinterleaver elements and channels decoder elements. That is, one deinterleaver element and one channel decoder element configure one decoding resource element.

Accordingly, the decoding resources 320 form a total of eight decoding resource elements in accordance with the third embodiment of the present invention. The decoding resource elements deinterleave and decode their own input signals and then output the deinterleaved and decoded signals.

Although, an example in which the number of decoding resource elements is eight has been described above, more than eight decoding resource elements can be provided. That is, when four or more channels are simultaneously displayed using the PIP scheme, at least ten decoding resource elements must be provided. Those skilled in the art will appreciate that the number of decoding resource elements can be easily increased on the basis of the description of the present invention.

Additionally, the channel decoder elements can be implemented with a device for individually decoding data received through each channel, respectively. The channel decoder devices can be implemented within one decoder.

The channel decoder elements configuring the decoding resource elements output, to the MPEG decoder 308, data compressed in the MPEG-2 or MPEG-4 format corresponding to video and audio of the signals decoded on the basis of a video output control signal input from the controller 316. Other signals are output to the controller 316. Accordingly, when one broadcasting service is received through two channels, only decoded data of two channels is output to the MPEG decoder 308. When two broadcasting services are received through four channels, decoded data of the four channels is output to the MPEG decoder 308. When three broadcasting services are received through six channels, decoded data of the six channels is output to the MPEG decoder 308. The controller 316 can receive a CAS signal, an EPG signal, and a pilot signal and can obtain information about received video data, information about a channel state, etc.

The deinterleaver 304 includes three reserved deinterleaver elements 304c, 304d, and 304e as compared with the conventional deinterleaver. Moreover, the deinterleaver 304 deinterleaves broadcasting service traffic input on a channel-by-channel basis and outputs the deinterleaved traffic to an associated decoding resource element of the channel decoder 306.

The channel decoder 306 includes three reserved decoder elements 306c, 306d, and 306e as compared with the conventional decoder. Moreover, the decoder 306 decodes deinterleaved broadcasting service traffic output from the deinterleaver 304 through an associated channel decoder element. Data of Broadcasting Services A, B, and C in the decoded broadcasting service traffic is output from the channel decoder 306 to the MPEG decoder 308. The MPEG decoder 308 performs an associated decoding operation.

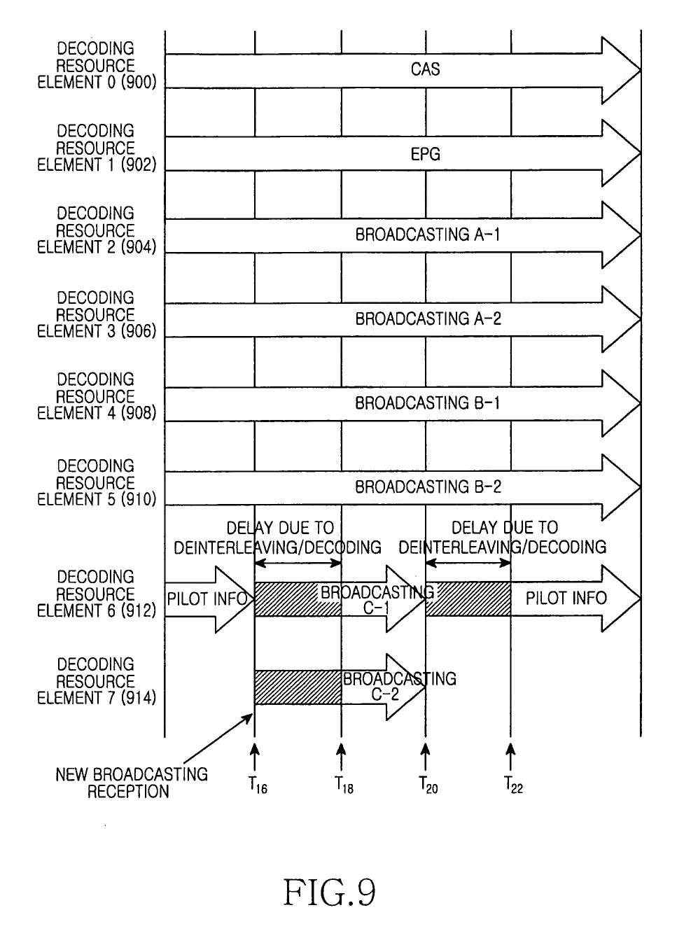

FIG. 9 is a timing diagram illustrating a process for processing data in decoding resources of FIG. 8 when a broadcasting service is changed in accordance with the third embodiment of the present invention. As compared with the decoding resource elements of FIG. 4 in accordance with the first embodiment of the present invention, decoding resource elements denoted by reference numerals 900 to 914 illustrated in FIG. 9 include two reserved decoding resource elements. Broadcasting service traffic is additionally decoded using Decoding Resource Elements 6 and 7 such that a broadcasting service change to be described below can be conveniently provided to the user.

Further, Reserved Decoding Resource Element-7 914 is additionally provided as compared with FIG. 4. Decoding Resource Element-6 912 for decoding the pilot signal is set as another reserved decoding resource element for a broadcasting service change. The two reserved decoding resource elements are used as decoding resource elements for performing demodulation, decoding, and deinterleaving when Broadcasting B associated with reference numerals 908 and 910 is changed to Broadcasting C associated with reference numerals 912 and 914.

A pilot signal received by Decoding Resource Element-6 912 contains information necessary for synchronization and control of the DMB receiver.

The synchronization information contained in the pilot signal is continuously received in the RAKE receiver 302. If necessary, control information of a broadcasting signal is output to a stage after the RAKE receiver 302 and undergoes decoding and deinterleaving processes. In the third embodiment of the present invention as compared with the conventional example of FIG. 1, Decoding Resource Element-4 908 and Decoding Resource Element-5 910 are set as reserved decoding resource elements for decoding data of Broadcasting Service B. Further, Decoding Resource Element-6 912 for decoding the pilot signal is set as a reserved decoding resource element for decoding data of Broadcasting Service C along with Decoding Resource Element-7 914.

At a time point T₁₆, when control information of the pilot signal is completely received, the controller 316 controls the RAKE receiver 302 such that the pilot signal is not output to the deinterleaver 304 through the MUX 303. The RF receiver 300 and the RAKE receiver 302 output data of new Broadcasting Service C to Decoding Resource Element-6 912 for decoding the pilot signal and Reserved Decoding Resource Element-7 914 in the decoding resources 320 at the time point T₁₆.

When the data of Broadcasting Service C is input to Decoding Resource Element-6 912 and Decoding Resource Element-7 914, delay is caused by the deinterleaving and decoding operations.

A time point T₁₈ is a time point at which the delay caused by the deinterleaving and decoding operations for Broadcasting Service C is ended.

Three Broadcasting Services A, B, and C can be provided to the user from the time point T₁₈. When the user makes a request for a change from Broadcasting Service B, currently being provided to the user, to Broadcasting Service A associated with reference numerals 904 and 906 or Broadcasting Service C associated with reference numerals 912 and 914 in a time interval between the time point T₁₈ and a time interval T₂₀, the controller 316 outputs data of a broadcasting service, selected by the user, to the display unit 312 and the speaker 314 in real-time.

If control information of the pilot signal is required during a time interval between the time point T₂₀ and a time point T₂₂, the controller 316 determines if a reserved decoding resource element is present. If a reserved decoding resource element is present, the controller 316 adjusts an output of the MUX 303 and outputs the pilot signal to the decoding resources 320. In the third embodiment of the present invention, Decoding Resource Element-6 912 for decoding data of Broadcasting Service C is selected as a reserved decoding resource element in the decoding resources 320. Decoding Resource Element-6 912 decodes the received pilot signal and outputs the decoded signal to the controller 316.

A broadcasting change procedure in the digital broadcasting system in accordance with the third embodiment of the present invention is the same as the procedure of FIGS. 5A and 5B, except that two reserved decoding resource elements for decoding data of Broadcasting Service C are added in the third embodiment of the present invention.

More specifically, in the first embodiment of the present invention, Decoding Resource Element-4 408 is set as a decoding resource element capable of stopping the decoding operation on service traffic. However, in the third embodiment of the present invention, Decoding Resource Element-6 912 is set as a decoding resource element capable of stopping the decoding operation on service traffic. The data decoded in the reserved decoding resource elements 912 and 914 corresponds to Broadcasting Service C. When a channel in which the decoding operation has been stopped needs to be resumed while three Broadcasting Services A, B, and C are provided to the user, Broadcasting Service C-1 associated with reference numeral 912 is set as a low-priority signal.

The DMB receiving terminal can decode all data of current Broadcasting Services A, B, and C in accordance with the third embodiment of the present invention. Even when a channel is changed to a front or rear channel while the user watches a currently provided broadcast, for example, Broadcasting Service B, the delay due to the deinterleaving/decoding operations does not occur. Accordingly, the user can receive a broadcasting service in which a channel is changed in realtime.

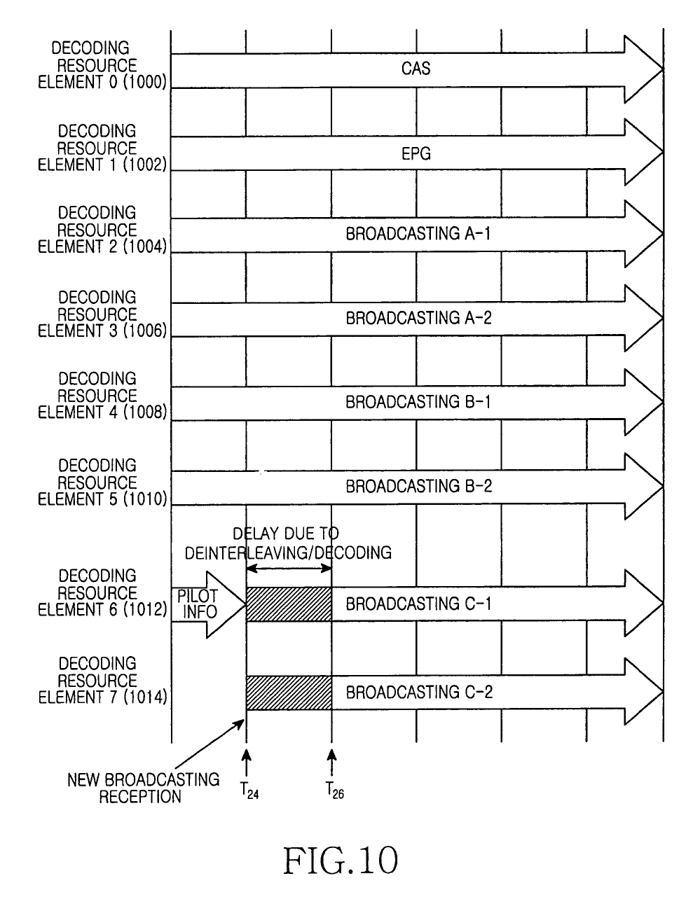

FIG. 10 is a timing diagram illustrating a process for processing data in the decoding resources of FIG. 8 when a PIP service is implemented in accordance with the fourth embodiment of the present invention. However, because decoding resource elements denoted by reference numerals 1000 to 1014 of FIG. 10 are the same as those denoted by reference numerals 900 to 914 of FIG. 9, their description is omitted below.

Referring to FIG. 10, after Decoding Resource Element-6 1012 completely receives control information of the pilot channel, the controller 316 stops the deinterleaving and decoding operations on the pilot channel at a time point T₂₄. Decoding Resource Element-6 1012 and Decoding Resource Element-7 1014 decode data of new Broadcasting Service C. Accordingly, when Broadcasting Service C is provided to the user, the delay due to the decoding and deinterleaving operations occurs between the time point T₂₄ and a time point T₂₆. The time point T₂₆ is a time point when the delay due to the deinterleaving and decoding operations on data of Broadcasting Service C is ended. Because the deinterleaving and decoding operations are performed on data of Broadcasting Services A, B, and C in real-time at the time point T₂₆, the controller 316 can control the video/audio processor 310 to provide the PIP service.

A broadcasting change procedure in the DMB system in accordance with the fourth embodiment of the present invention is the same as that of FIG. 7, except that in the fourth embodiment of the present invention, two reserved decoding resource elements for decoding data of Broadcasting Service C are added.

More specifically, in the second embodiment of the present invention, Decoding Resource Element-4 608 is set as a decoding resource element capable of stopping the decoding operation on service traffic. Further, in the third embodiment of the present invention, Decoding Resource Element-6 912 is set as a decoding resource element capable of stopping the decoding operation on service traffic. The data decoded in the reserved decoding resource elements 912 and 914 corresponds to Broadcasting Service C. However, in the fourth embodiment of the present invention, Decoding Resource Element-6 1012 is set as a decoding resource element capable of stopping the decoding operation on service traffic. The data decoded in the reserved decoding resource elements 1012 and 1014 corresponds to Broadcasting Service C.

In accordance with the fourth embodiment of the present invention, the user can select another broadcasting service in addition to currently provided Broadcasting Service B of Broadcasting Services A, B, and C currently being received and can receive the PIP service through the display unit 312 and the speaker 314.

As is apparent from the above description, the present invention can reduce an inconvenience, felt by users, due to a stopped broadcasting service during a predetermined time period when a broadcasting service is changed in response to a broadcasting change request. Moreover, the present invention can provide the convenience to the users by providing a picture in picture (PIP) service.

Moreover, the present invention prevents an increase in power consumption because only a minimum of reserved decoding resource elements is additionally provided and therefore the configuration of a digital multimedia broadcasting (DMB) receiver is simplified.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for receiving a broadcasting service in a digital multimedia broadcasting (DMB) system, the DMB system receiving a pilot channel, an electronic program guide (EPG) channel, a conditional access system (CAS) channel, and two broadcasting service traffic channels for transferring one boradcasting service, comprising the steps of:
decoding broadcasting service traffic of a first broadcasting service;
providing the first broadcasting service of the decoded traffic to a user;
determining if a reserved decoding resource element is present;
newly receiving a second broadcasting service through an identified reserved decoding resource element while the first broadcasting service is provided to a user;
decoding traffic of the received second broadcasting service, after a preset time; and
simultaneously providing the first broadcasting service and the second broadcasting service of the decoded traffic to the user.

2. The method of claim 1, further comprising the steps of:
determining if another reserved decoding resource element is present when control information is required while the first broadcasting service and the second broadcasting service are provided to the user; and
receiving the control information through an identified reserved decoding resource element.

3. The method of claim 1, wherein the step of determining if the reserved decoding resource element is present comprises the steps of:
searching for the reserved decoding resource element;
selecting a low-priority channel from among channels currently being decoded, if the reserved decoding resource element is not present; and
selecting a decoding resource element for decoding the low-priority channel as the reserved decoding resource element.

4. A method for changing a broadcasting service in a terminal for receiving a plurality of digital multimedia broadcasting (DMB) services, comprising the steps of:
determining if a reserved decoding resource element is present while data of a first broadcasting service is decoded and output;
determining whether to stop decoding a pilot channel if the reserved decoding resource element is present;
receiving and decoding data of a second broadcasting service using the reserved decoding resource element and a decoding resource element for decoding the pilot channel, if the reserved decoding resource element is present; and
stopping an output of the first broadcasting service and outputting the data of the second broadcasting service, when a user changes to the second broadcasting service.

5. The method of claim 4, wherein decoding the pilot channel is stopped according to a change of control information.

6. A method for changing a broadcasting service in a terminal for receiving a plurality of digital multimedia broadcasting (DMB) services, comprising the steps of:
searching for a reserved decoding resource element while data of a first broadcasting service is decoded and output;
determining whether to stop decoding a pilot channel when the reserved decoding resource element is present;
receiving and decoding data of a second broadcasting service using the reserved decoding resource element and a decoding resource element for decoding the pilot channel, when the operation for decoding the pilot channel is stopped; and
simultaneously outputting the data of the first and second broadcasting services, when a user changes to the second broadcasting service.

7. The method of claim 6, wherein decoding the pilot channel is stopped according to a change of control information.

8. A receiver for receiving a broadcasting service in a terminal of a digital multimedia broadcasting (DMB) system, the DMB system receiving a pilot channel, an electronic program guide (EPG) channel, a conditional access system (CAS) channel, and two broadcasting service traffic channels, comprising:
decoding resources for receiving and decoding data of a first broadcasting service, and receiving and decoding data of a second broadcasting service through a reserved decoding resource element, while the first broadcasting service is provided to a user; and
a controller for determining if the reserved decoding resource element for receiving the second broadcasting service is present while the first broadcasting service is received.

9. The receiver of claim 8, further comprising:
a deinterleaver for deinterleaving the received data of the first and second broadcasting services.

10. The receiver of claim 8, wherein the controller determines if a reserved decoding resource element is present when control information is required while the first and second broadcasting services are provided to the user, and receives and decodes the control information through an identified reserved decoding resource element if the reserved decoding resource element is present.

11. The receiver of claim 10, wherein the controller selects a decoding resource element for decoding a low-priority channel among channels currently being decoded, if the reserved decoding resource element is not present, and receives and decodes the control information using the selected decoding resource element.

12. A method for receiving a broadcasting service in a digital multimedia broadcasting (DMB) system, the DMB system receiving a pilot channel, an electronic program guide (EPG) channel, a conditional access system (CAS) channel, and two broadcasting service traffic channels for transferring one boradcasting service, comprising the steps of:
decoding broadcasting service traffic of first and second broadcasting services;
providing the first and second broadcasting services of the decoded traffic to a user;
determining if a reserved decoding resource element is present;
newly receiving a third broadcasting service through an identified reserved decoding resource element, while the first and second broadcasting services are provided to the user;
decoding traffic of the received third broadcasting service, after a preset time; and
simultaneously providing the first and second broadcasting services and the third broadcasting service of the decoded traffic to the user.

13. The method of claim 12, further comprising the steps of:
determining if a reserved decoding resource element is present when control information is required while the first broadcasting service, the second broadcasting service, and the third broadcasting service are provided to the user; and
receiving the control information through an identified reserved decoding resource element.

14. The method of claim 12, wherein the step of determining if the reserved decoding resource element is present comprises the steps of:
searching for the reserved decoding resource element;
selecting a low-priority channel from channels currently being decoded, if the reserved decoding resource element is not present; and
selecting a decoding resource element for decoding the low-priority channel as the reserved decoding resource element.

15. A method for changing and receiving a broadcasting service in a terminal for receiving a plurality of digital multimedia broadcasting (DMB) services, comprising the steps of:
determining if a reserved decoding resource element is present while data of first and second broadcasting services is decoded and output;
determining whether to stop decoding a pilot channel, if the reserved decoding resource element is present;
receiving and decoding data of a third broadcasting service using the reserved decoding resource element and a decoding resource element for decoding the pilot channel, when the operation for decoding the pilot channel is stopped; and
stopping an output of the first and second broadcasting services currently being provided and outputting the data of the third broadcasting service, when a user changes to the third broadcasting service.

16. The method of claim 15, wherein decoding the pilot channel is stopped according to a change of control information.

17. A method for changing and receiving a broadcasting service in a terminal for receiving a plurality of digital multimedia broadcasting (DMB) services, comprising the steps of:
determining if a reserved decoding resource element is present while data of first and second broadcasting services is decoded and output;
determining whether to stop decoding a pilot channel, if the reserved decoding resource element is present;
receiving and decoding data of a third broadcasting service using the reserved decoding resource element and a decoding resource element for decoding the pilot channel, when decoding the pilot channel is stopped; and
simultaneously outputting the data of the second and third broadcasting services, when a user changes to the third broadcasting service.

18. The method of claim 17, further comprising the step of:
simultaneously outputting the data of the first and third broadcasting services, when the user changes to the third broadcasting service.

19. The method of claim 17, further comprising the step of:
simultaneously outputting the data of the first, second, and third broadcasting services to the user.

20. The method of claim 17, wherein decoding the pilot channel is stopped according to a change of control information.

21. A receiver for receiving a broadcasting service in a terminal of a digital multimedia broadcasting (DMB) system, the DMB system receiving a pilot channel, an electronic program guide (EPG) channel, a conditional access system (CAS) channel, and two broadcasting service traffic channels, comprising:
decoding resources for receiving and decoding data of first and second broadcasting services, and receiving and decoding data of a third broadcasting service through a reserved decoding resource element, while the first and second broadcasting services are provided to a user; and
a controller for determining if the reserved decoding resource element for receiving the third broadcasting service is present, while the first and second broadcasting services are received.

22. The receiver of claim 21, further comprising:
a deinterleaver for deinterleaving the received data of the first, second, and third broadcasting services.

23. The receiver of claim 21, wherein the controller determines if a reserved decoding resource element is present when control information is required, while the first and second broadcasting services are provided to the user, and receives and decodes the control information through an identified reserved decoding resource element, if the reserved decoding resource element is present.

24. The receiver of claim 23, wherein the controller selects a decoding resource element for decoding a low-priority channel among channels currently being decoded, if the reserved decoding resource element is not present, and receives and decodes the control information using the selected decoding resource element.
